(19) United States
(12) Patent Application Publication
(10) Pub. No.: US 2014/0190256 A1
(43) Pub. Date: Jul. 10, 2014

(54) VIBRATORY GYRO SENSOR SYSTEM

(71) Applicant: SAMSUNG ELECTRO-MECHANICS CO., LTD., (US)

(72) Inventors: Sung Tae Kim, Suwon (KR); Young Kil Choi, Suwon (KR); Jun Kyung Na, Suwon (KR); Seung Chul Pyo, Suwon (KR); Chang Hyun Kim, Suwon (KR)

(73) Assignee: SAMSUNG ELECTRO-MECHANICS CO., LTD., Suwon (KR)

(21) Appl. No.: 13/845,054

(22) Filed: Mar. 17, 2013

(30) Foreign Application Priority Data
Dec. 24, 2012 (KR) 10-2012-0152272

(51) Int. Cl. G01C 19/5776

(52) U.S. Cl. CPC G01C 19/5776
USPC 73/504.12

(57) ABSTRACT

Disclosed herein is a vibratory gyro sensor system, including: a driving unit shifting a signal output from a first sensing element of a gyro sensor by a preset shift phase, amplifying the phase shifted signal to a preset gain, and self-oscillates the amplified signal to generate and feedback a driving signal; an automatic gain control unit converting and amplifying capacitance output from a second sensing element of a gyro sensor into voltage; and a signal detection unit converting and amplifying the capacitance output from the first sensing element and the second sensing element into voltage.

### CROSS REFERENCE TO RELATED APPLICATION

This application claims the benefit of Korean Patent Application No. 10-2012-0152272, filed on Dec. 24, 2012, entitled “Gyro Sensors System for a Vibratory Capable” which is hereby incorporated by reference in its entirety into this application.

### BACKGROUND OF THE INVENTION

1. Technical Field

The present invention relates to a vibratory gyro sensor system.

2. Description of the Related Art

A gyro sensor, which is a sensor detecting angular velocity, has been mainly used for a posture control of an aircraft, a rocket, a robot, and the like, handshaking correction of a camera, binoculars, and the like, vehicle sliding, a lateral turning prevention system, navigation, and the like. Recently, the gyro sensor is also installed in a smart phone, and thus has been used for various applications.

There are various types of gyro sensors. For example, rotatable, vibratory, hydraulic, optical gyro sensors, and the like, have been used. Currently, the vibratory gyro sensor has been mainly used for mobile products.

Currently, the vibratory gyro sensor mainly uses a capacitive type comb structure and partly uses a piezoelectric type.

As a system of allowing a vibratory gyro sensor to process a signal, there are a system configured of a driving unit representing a phase locked loop (PLL), an automatic gain control (AGC), and a signal detection unit and a system configured of a driving unit and a signal detection unit without an automatic gain control.

The PLL included in the gyro sensor system, which is a unit allowing the signal detection unit and the driving unit to have a phase difference of 90°, has a large size and considerable consumption current, such that a lot of load may be applied to the gyro sensor system.

When the gyro sensor system does not configure the automatic gain control function, the gyro sensor system does not efficiently cope with a change in process conditions (PVT) that represent a process (P), voltage (V), or temperature (T).

### RELATED ART DOCUMENT

### Patent Document

(Patent Document 1) JP Patent Laid-Open Publication No. 2006-170620

### SUMMARY OF THE INVENTION

The present invention has been made in an effort to provide a vibratory gyro sensor system capable of implementing an automatic gain control (AGC) without using a phase locked loop.

According to a preferred embodiment of the present invention, there is provided a vibratory gyro sensor system, including: a driving unit shifting a signal output from a first sensing element of a gyro sensor by a preset shift phase, amplifying the phase shifted signal to a preset gain, and self-oscillates the amplified signal to generate and feedback a driving signal; an automatic gain control unit converting and amplifying capacitance output from a second sensing element of a gyro sensor into voltage, detecting peak voltage of the amplified output voltage to quantize the detected peak voltage into a digital signal, and using the quantized digital signal to generate a range of maximum voltage and minimum voltage of reference voltage so as to perform a control to adjust an amplitude range of the self oscillation of the driving unit; and a signal detection unit converting and amplifying the capacitance output from the first sensing element and the second sensing element into voltage, receives and demodulates the amplified output voltage and a phase shifted signal of the driving unit, and converting and detecting the demodulated signal into a digital signal.

According to another preferred embodiment of the present invention, there is provided a vibratory gyro sensor system, including: a driving unit shifting a signal output from a first sensing element of a gyro sensor by a preset shift phase, amplifying the phase shifted signal to a preset gain, and self-oscillates the amplified signal to generate and feedback a driving signal; an automatic gain control unit receiving the amplified signal of the driving unit, detecting peak voltage and quantizing the detected peak voltage into a digital signal, and using the quantized digital signal to generate a range of maximum voltage and minimum voltage of reference voltage so as to perform a control to adjust an amplitude range of the self oscillation of the driving unit; and a signal detection unit shifting and receiving the signals output from the first sensing element and the second sensing element by a preset shift phase, receives and demodulates a phase shifted signal of the driving unit, and converting and detecting the demodulated signal into a digital signal.

The driving unit may be configured of a function of shifting and outputting a phase of the signal output from the first sensing element of the gyro sensor by 90° as a differentiator.

The automatic gain control unit may configure a proportional integral derivative (PID) controller generating a range of maximum voltage and minimum voltage of reference voltage to perform a control to adjust an amplitude range of the self oscillation of the driving unit.

According to still another preferred embodiment of the present invention, there is provided a vibratory gyro sensor system, including: a driving unit converting capacitance output from a first sensing element and a second sensing element of a gyro sensor into voltage to receive amplified signals and shift the received signals by a preset shift phase, amplifying the phase shifted signal to a preset gain, and self-oscillates the amplified signal to generate and feedback a driving signal; an automatic gain control unit converting and amplifying capacitance output from the first sensing element and the second sensing element into voltage, detecting peak voltage of the amplified output voltage to quantize the detected peak voltage into a digital signal, and using the quantized digital signal to generate a range of maximum voltage and minimum voltage of reference voltage so as to perform a control to adjust an amplitude range of the self oscillation of the driving unit; and a signal detection unit converting and amplifying the capacitance output from the first sensing element and the second sensing element into voltage, receives and demodulates the amplified output voltage and a phase shifted signal of the driving unit, and converting and detecting the demodulated signal into a digital signal.

According to still yet another preferred embodiment of the present invention, there is provided a vibratory gyro sensor system, including: a driving unit receiving a phase shifted signal and shifting the received signal by a preset shift phase, amplifying the phase shifted signal to a preset gain, and self-oscillating the amplified signal to generate and feedback a driving signal; an automatic gain control unit shifting signals output from a first sensing element and a second sensing element of a gyro sensor by a preset shift phase, supplying the phase shifted signal to the driving unit, amplifying the phase shifted signal and detecting peak voltage of the amplified output voltage to quantize the detected peak voltage into a digital signal, and using the quantized digital signal to generate a range of maximum voltage and minimum voltage of reference voltage so as to perform a control to adjust an amplitude range of the self oscillation of the driving unit; and a signal detection unit shifting and receiving the signals output from the first sensing element and the second sensing element by a preset shift phase, receives and demodulates a phase shifted signal of the driving unit, and converting and detecting the demodulated signal into a digital signal.

The driving unit may configure a function of receiving the amplified signals and shifting and outputting a phase of the signals by 90° as a differentiator.

The automatic gain control unit and the signal detection unit may configure a function of shifting and outputting a phase of the signals by a preset shift phase.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a configuration of a vibratory gyro sensor system without PLL according to a first preferred embodiment of the present invention;

FIG. 2 is a block diagram illustrating a configuration of a vibratory gyro sensor system without PLL according to a second preferred embodiment of the present invention;

FIG. 3 is a block diagram illustrating a configuration of a vibratory gyro sensor system without PLL according to a third preferred embodiment of the present invention; and

FIG. 4 is a block diagram illustrating a configuration of a vibratory gyro sensor system without PLL according to a fourth preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

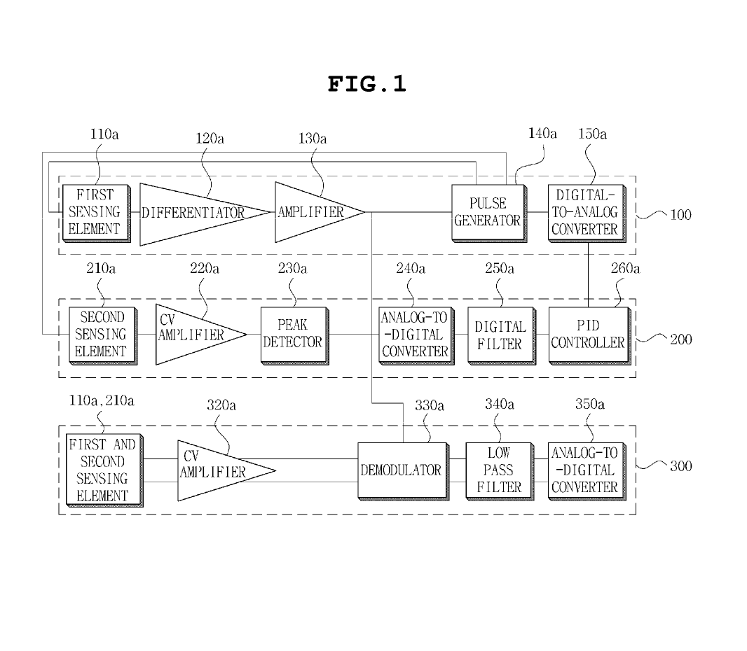

FIG. 1 is a block diagram illustrating a configuration of a vibratory gyro sensor system without PLL according to a first preferred embodiment of the present invention.

The vibratory gyro sensor system according to the first preferred embodiment of the present invention is a self-oscillating feedback circuit required to drive a gyro sensor and is configured to include a driving unit 100, an automatic gain control (AGC) unit 200, and a signal detection unit 300.

The driving unit 100 may include a differentiator 120a, an amplifier 130a, a pulse generator 140a, and a digital-to-analog converter 150a. In this configuration, the digital-to-analog converter 150a will be described in the automatic gain control unit 200.

The differentiator 120a shifts a signal output from a first sensing element 110a of the gyro sensor as much as a preset shift phase.

That is, the shift phase is set to be 90° so that the phase shift satisfies an oscillation condition.

The amplifier 130a amplifies a 90° phase shifted signal by the differentiator to a preset gain and transmits the amplified signal to the pulse generator 140a.

The pulse generator 140a self-oscillates the amplified signal from the amplifier 130a to generate the driving voltage and feedbacks the generated driving voltage to a second sensing element 210a of an automatic gain control unit 200.

In order to satisfy the oscillation phase condition of the gyro sensor, the differentiator 120a may shift voltage from the first sensing element 110a as much as a preset phase to generate the driving voltage.

The differentiator 120a sets the shift phase of 90° so that the phase shift of a signal satisfies the oscillation condition in a signal path including the pulse generator 140a.

For example, when the phase shift of the signal is 90° in the signal path of the first sensing element 110a, the differentiator 120a, the amplifier 130a, the pulse generator 140a, the phase shift of the differentiator may be set to be 90°.

The condition under which the gyro sensor is resonated is that a phase of an open loop is 180° and a gain of a signal is 1.

In this case, the differentiator 120a and the amplifier 130a satisfy the resonance conditions so that the gyro sensor is self-oscillated.

The automatic gain control 200 may include a second sensing element 210a of a gyro sensor, a CV amplifier 220a, a peak detector 230a, an analog-to-digital converter 240a, a digital filter 250a, and a proportional integral derivative (PID) controller 260a.

The second sensing element 210a of the gyro sensor receives the 90° phase shifted signal from the pulse generator 140a.

The CV amplifier 220a is configured of a charge amplifier and converts and amplifies capacitance of the second sensing element 210a into voltage.

The peak detector 230a is configured of a root-mean-square (RMS) detector and detects peak voltage of output voltage of the CV amplifier 220a.

The analog-to-digital converter 240a converts an analog signal having the peak voltage detected by the peak detector 230a into a digital signal to output a quantization signal having a bit form via a digital filter 250a.

The PID controller 260a, which is a feedback controller to keep reference voltage at the time of self-oscillating the output signal of the digital filter 250a, is configured by connecting a proportional control multiplying a proportional constant gain by an error signal between reference voltage and current voltage to form a control signal, an integral control forming a control signal by integrating the error signal, and a differential control forming a control signal by differentiating the error signal with a proportional control in parallel.

The PID controller 260a uses a quantized signal output from the digital filter 250a to generate a range of maximum voltage and minimum voltage of reference voltage by using a method of reducing a gain when the reference voltage is larger than a reference to reduce a gain and increasing a gain when the reference voltage is smaller than a reference to increase voltage, thereby performing a control to adjust an amplitude range of self oscillation of the pulse generator 140a.

The digital-to-analog converter 150a converts a digital signal between maximum reference voltage and minimum reference voltage controlled by the PID controller 260a into a continuous analog signal and supplies the converted analog signal as an input signal of the pulse generator 140a.

The pulse generator 140a determines the amplitude range of the self oscillation according to the maximum reference voltage and the minimum reference voltage output from the digital-to-analog converter 150a and generates and feedbacks the driving voltage within a predetermined range of amplitude.

The signal detection unit 300 may include a first sensing element 110a and a second sensing element 210a of the gyro sensor, a CV amplifier 320a, a demodulator 330a, a low pass filter 340a, and an analog-to-digital converter 350a.

The CV amplifier 320a converts and amplifies capacitance of signals of 0° and 180° output from the first sensing element 110a and the second sensing element 210a of the gyro sensor into voltage.

The demodulator 330a receives and demodulates the output voltage of 0° and 180° from the CV amplifier 320a and the 90° phase shifted signal output from the amplifier 130a of the driving unit 100. In this case, the demodulated output signal is converted into a digital signal by the analog-to-digital converter 350a via the low pass filter 340a.

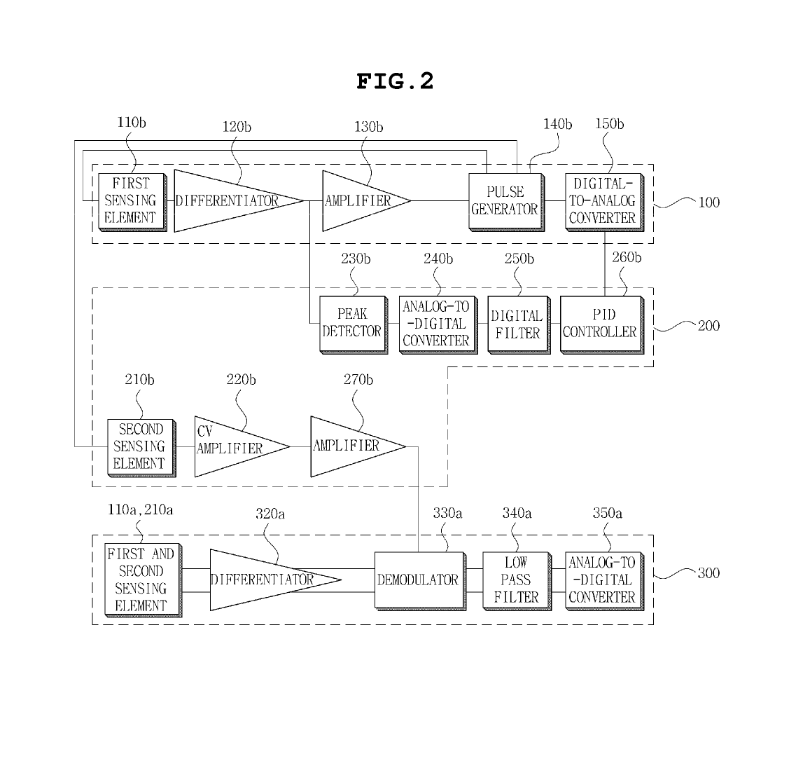

Next, a vibratory gyro sensor system according to a second preferred embodiment of the present invention will be described in detail with reference to FIG. 2.

FIG. 2 is a block diagram illustrating a configuration of the vibratory gyro sensor system according to a second preferred embodiment of the present invention.

The vibratory gyro sensor system according to the second preferred embodiment of the present invention may include the driving unit 100 that includes a first sensing element 110b of a gyro sensor, a differentiator 120b, an amplifier 130b, a pulse generator 140b, and a digital-to-analog converter 150b, the automatic gain control unit 200 that includes a second sensing element 210b, a CV amplifier 220b, a peak detector 230b, an analog-to-digital converter 240b, a digital filter 250b, a PID controller 260b, and an amplifier 270b, and a signal detection unit 300 that includes the first sensing element 110b and the second sensing element 210b of the gyro sensor, a differentiator 320b, a demodulator 330b, a low pass filter 340b, and an analog-to-digital converter 350b.

The differentiator 120b shifts a signal output from the first sensing element 110a of the gyro sensor as much as a preset shift phase.

The amplifier 130b amplifies a 90° phase shifted signal by the differentiator 120b to a preset gain and transmits the amplified signal to the pulse generator 140b.

The pulse generator 140b self-oscillates the signal amplified by the amplifier 130a to generate the driving voltage and feedbacks the generated driving voltage to the first sensing element 110b and the second sensing element 210b of an automatic gain control unit 200.

The peak detector 230b receives 90° phase shifted voltage from the differentiator 120b to output the peak value voltage.

The analog-to-digital converter 240a converts an analog signal having the peak voltage detected by the peak detector 230a into a digital signal to output a quantization signal having a bit form via a digital filter 250a.

The PID controller 260b uses the quantized signal output from the digital filter 250c to generate a range of maximum voltage and minimum voltage of reference voltage, thereby performing a control to adjust an amplitude range of self oscillation of the pulse generator 140b.

The digital-to-analog converter 150b converts a digital signal of maximum reference voltage controlled by the PID controller 260b into a continuous analog signal and supplies the converted analog signal as an input signal of the pulse generator 140a.

Meanwhile, the second sensing element 210b of the gyro sensor receives the 90° phase shifted signal from the pulse generator 140a.

The CV amplifier 220b is configured of a charge amplifier and converts and amplifies capacitance of the second sensing element 210b into voltage.

In addition, the amplifier 270b amplifies the voltage output from the CV amplifier 220b so as to be suitable for a voltage level of the demodulator 330b and outputs the amplified voltage output to the demodulator 330b.

Next, the differentiator 320b shifts and outputs a phase of signals of 0° and 180° output from the first sensing element 110b and the second sensing element 210b of the gyro sensor by 90°.

The demodulator 330b receives the output voltage (a signal obtained by shifting a phase of signals of 0° and 180° by 90°) from the differentiator 320b and receives and demodulates the signal amplified to a preset gain from the amplifier 270b. In this case, the demodulated output signal is converted into a digital signal by the analog-to-digital converter 350b via the low pass filter 340b.

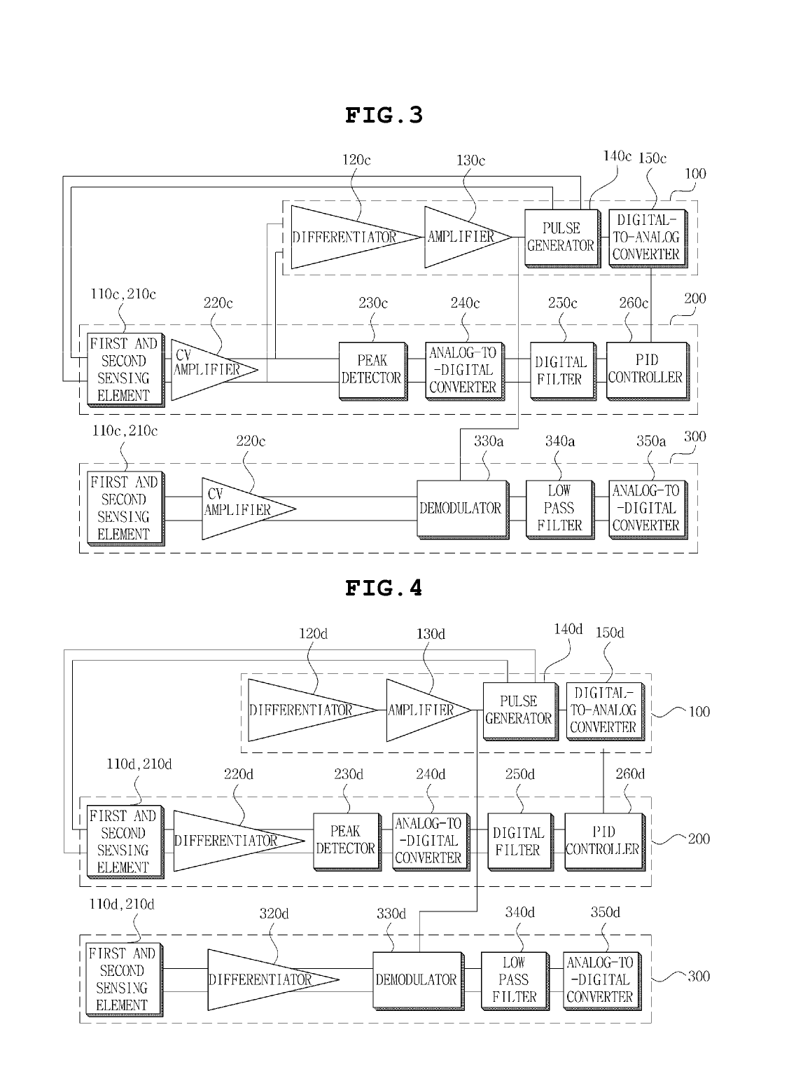

Next, a vibratory gyro sensor system without a PLL according to a third preferred embodiment of the present invention will be described in detail with reference to FIG. 3.

FIG. 3 is a block diagram illustrating a configuration of the vibratory gyro sensor system without PLL according to the third preferred embodiment of the present invention.

The vibratory gyro sensor system according to the third preferred embodiment of the present invention may include the driving unit 100 that includes a differentiator 120c, an amplifier 130c, a pulse generator 140c, and a digital-to-analog converter 150c, the automatic gain control unit 200 that includes first and second sensing elements 110c and 210c of a gyro sensor, a CV amplifier 220c, a peak detector 230c, an analog-to-digital converter 240c, a digital filter 250c, and a PID controller 260c, and a signal detection unit 300 that includes the first sensing element 110c and the second sensing element 210c of the gyro sensor, a CV amplifier 320c, a demodulator 330c, a low pass filter 340c, and an analog-to-digital converter 350c.

The CV amplifier 220c of the automatic gain control unit 200 converts and amplifies each capacitance of the first sensing element 110c and the second sensing element 210c of the gyro sensor into voltage and supplies the amplified signals to the differentiator 120c of the driving unit 100.

The peak detector 230a detects the peak voltage of the output voltage of the CV amplifier 220a.

The analog-to-digital converter 240c converts an analog signal having the peak voltage detected by the peak detector 230c into a digital signal to output a quantization signal having a bit form via a digital filter 250a.

The PID controller 260c uses the quantized signal output from the digital filter 250c to generate a range of the maximum voltage and the minimum voltage of the reference voltage, thereby performing a control to adjust an amplitude range of self oscillation of the pulse generator 140c.

The differentiator 120c of the driving unit 100 receives the amplified signals from the CV amplifier 220c of the automatic gain control unit 200 to output 90° phase shifted voltage.

The amplifier 130c amplifies a 90° phase shifted signal by the differentiator 120c to a preset gain and transmits the amplified signal to the pulse generator 140c.

The pulse generator 140c self-oscillates the signal amplified by the amplifier 130c to generate the driving voltage and feedbacks the generated driving voltage to the first sensing element 110c and the second sensing element 210c of the gyro sensor.

The digital-to-analog converter 150c converts a digital signal into a continuous analog signal and supplies the converted analog signal as an input signal of the pulse generator.

The CV amplifier 320c of the signal detection unit 300 converts and amplifies each capacitance of the first sensing element 110c and the second sensing element 210c of the gyro sensor into voltage and supplies the amplified signals to the demodulator 330c.

The demodulator 330c receives the amplified signals from the CV amplifier 320c and amplifies, receives, and demodulates the 90° phase shifted signal to a preset gain from the amplifier 130c of the driving unit 100. In this case, the demodulated output signal is converted into a digital signal by the analog-to-digital converter 350c via the low pass filter 340c.

Next, a vibratory gyro sensor system according to a fourth preferred embodiment of the present invention will be described in detail with reference to FIG. 4.

FIG. 4 is a block diagram illustrating a configuration of the vibratory gyro sensor system according to the fourth preferred embodiment of the present invention.

The vibratory gyro sensor system according to the fourth preferred embodiment of the present invention may include the driving unit 100 that includes a differentiator 120d, an amplifier 130d, a pulse generator 140d, and a digital-to-analog converter 150d, the automatic gain control unit 200 that includes first and second sensing elements 110d and 210d of a gyro sensor, a differentiator 220d, a peak detector 230d, an analog-to-digital converter 240d, a digital filter 250d, and a PID controller 260d, and a signal detection unit 300 that includes the first sensing element 110d and the second sensing element 210d of the gyro sensor, a differentiator 320d, a demodulator 330d, a low pass filter 340d, and an analog-to-digital converter 350d.

The differentiator 220d of the automatic gain control unit 200 shifts a phase of signals of 0° and 180° output from the first sensing element 110d and the second sensing element 210d by 90° and supplies the shifted signal to the peak detector 230d and the differentiator 120c of the driving unit 100.

The peak detector 230d detects the peak voltage of 90° phase shifted output voltage of the differentiator 220d.

The analog-to-digital converter 240d converts an analog signal having the peak voltage detected by the peak detector 230d into a digital signal to output a quantization signal having a bit form via a digital filter 250a.

The PID controller 260d uses the quantized signal output from the digital filter 250d to generate a range of maximum voltage and minimum voltage of reference voltage, thereby performing a control to adjust an amplitude range of the pulse generator 140d.

The differentiator 120d of the driving unit 100 receives the 90° phase shifted amplified signals from the differentiator 220d of the automatic gain control unit 200 to output 90° phase shifted voltage again.

The amplifier 130d amplifies a 180° phase shifted signal by the differentiator 120d to a preset gain and transmits the amplified signal to the pulse generator 140d.

The pulse generator 140d self-oscillates the signal amplified by the amplifier 130d to generate the driving voltage and feedbacks the generated driving voltage to the first sensing element 110b and the second sensing element 210 of the gyro sensor.

The digital-to-analog converter 150d converts a digital signal into a continuous analog signal and supplies the converted analog signal as an input signal of the pulse generator.

The differentiator 320d of the signal detection unit 300 shifts a phase of signals of 0° and 180° output from the first sensing element 110d and the second sensing element 210d of the gyro sensor by 90° and supplies the shifted signal to the demodulator 330d.

The demodulator 330d receives the phase shifted signals from the differentiator 320d and amplifies, receives, and demodulates the 180° phase shifted signals to a preset gain from the amplifier 130d of the driving unit 100. In this case, the demodulated output signal is converted into a digital signal by the analog-to-digital converter 350d via the low pass filter 340d.

As set forth above, according to the preferred embodiments of the present invention, it is possible to implement the automatic gain control (AGC) without using the phase locked loop, thereby reducing the power consumption and the size.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A vibratory gyro sensor system, comprising:
a driving unit shifting a signal output from a first sensing element of a gyro sensor by a preset shift phase, amplifying the phase shifted signal to a preset gain, and self-oscillates the amplified signal to generate and feedback a driving signal;
an automatic gain control unit converting and amplifying capacitance output from a second sensing element of a gyro sensor into voltage, detecting peak voltage of the amplified output voltage to quantize the detected peak voltage into a digital signal, and using the quantized digital signal to generate a range of maximum voltage and minimum voltage of reference voltage so as to perform a control to adjust an amplitude range of the self oscillation of the driving unit; and
a signal detection unit converting and amplifying the capacitance output from the first sensing element and the second sensing element into voltage, receiving and demodulating the amplified output voltage and a phase shifted signal of the driving unit, and converting and detecting the demodulated signal into a digital signal.

2. The vibratory gyro sensor system as set forth in claim 1, wherein the driving unit is configured of a function of shifting and outputting a phase of the signal output from the first sensing element of the gyro sensor by 90° as a differentiator.

3. The vibratory gyro sensor system as set forth in claim 1, wherein the automatic gain control unit configures a proportional integral derivative (PID) controller generating a range of maximum voltage and minimum voltage of reference voltage to perform a control to adjust an amplitude range of the self oscillation of the driving unit.

4. A vibratory gyro sensor system, comprising:
a driving unit shifting a signal output from a first sensing element of a gyro sensor by a preset shift phase, amplifying the phase shifted signal to a preset gain, and self-oscillates the amplified signal to generate and feedback a driving signal;
an automatic gain control unit receiving the amplified signal of the driving unit, detecting peak voltage and quantizing the detected peak voltage into a digital signal, and using the quantized digital signal to generate a range of maximum voltage and minimum voltage of reference voltage so as to perform a control to adjust an amplitude range of the self oscillation of the driving unit; and
a signal detection unit shifting and receiving the signals output from the first sensing element and the second sensing element by a preset shift phase, receives and demodulates a phase shifted signal of the driving unit, and converting and detecting the demodulated signal into a digital signal.

5. The vibratory gyro sensor system as set forth in claim 4, wherein the driving unit is configured of a function of shifting and outputting a phase of the signal output from the first sensing element of the gyro sensor by 90° as a differentiator.

6. The vibratory gyro sensor system as set forth in claim 4, wherein the automatic gain control unit configures a proportional integral derivative (PID) controller generating a range of maximum voltage and minimum voltage of reference voltage to perform a control to adjust an amplitude range of the self oscillation of the driving unit.

7. The vibratory gyro sensor system as set forth in claim 4, wherein the signal detection unit converts the capacitance of the second sensing element of the gyro sensor fed back and supplied with the phase shifted signal of the driving unit into voltage and amplifying the converted voltage to a preset gain to be supplied as an input signal at the time of demodulation.

8. A vibratory gyro sensor system, comprising:
a driving unit converting capacitance output from a first sensing element and a second sensing element of a gyro sensor into voltage to receive amplified signals and shift the received signals by a preset shift phase, amplifying the phase shifted signal to a preset gain, and self-oscillates the amplified signal to generate and feedback a driving signal;
an automatic gain control unit converting and amplifying capacitance output from the first sensing element and the second sensing element into voltage, detecting peak voltage of the amplified output voltage to quantize the detected peak voltage into a digital signal, and using the quantized digital signal to generate a range of maximum voltage and minimum voltage of reference voltage so as to perform a control to adjust an amplitude range of the self oscillation of the driving unit; and
a signal detection unit converting and amplifying the capacitance output from the first sensing element and the second sensing element into voltage, receives and demodulates the amplified output voltage and a phase shifted signal of the driving unit, and converting and detecting the demodulated signal into a digital signal.

9. The vibratory gyro sensor system as set forth in claim 8, wherein the driving unit configures a function of receiving the amplified signals and shifting and outputting a phase of the signals by 90° as a differentiator.

10. A vibratory gyro sensor system, comprising:
a driving unit receiving a phase shifted signal and shifting the received signal by a preset shift phase, amplifying the phase shifted signal to a preset gain, and self-oscillating the amplified signal to generate and feedback a driving signal;
an automatic gain control unit shifting signals output from a first sensing element and a second sensing element of a gyro sensor by a preset shift phase, supplying the phase shifted signal to the driving unit, amplifying the phase shifted signal and detecting peak voltage of the amplified output voltage to quantize the detected peak voltage into a digital signal, and using the quantized digital signal to generate a range of maximum voltage and minimum voltage of reference voltage so as to perform a control to adjust an amplitude range of the self oscillation of the driving unit; and
a signal detection unit shifting and receiving the signals output from the first sensing element and the second sensing element by a preset shift phase, receives and demodulates a phase shifted signal of the driving unit, and converting and detecting the demodulated signal into a digital signal.

11. The vibratory gyro sensor system as set forth in claim 10, wherein the driving unit configures a function of receiving the amplified signals and shifting and outputting a phase of the signals by 90° as a differentiator.

12. The vibratory gyro sensor system as set forth in claim 10, wherein the automatic gain control unit and the signal detection unit configure a function of shifting and outputting a phase of the signals by a preset shift phase.
